(19) United States
(12) Patent Application Publication
(10) Pub. No.: US 2011/0096534 A1
(43) Pub. Date: Apr. 28, 2011

(54) High-Voltage Under-Cabinet Puck Light

(76) Inventor: Zhirong Lee, Wenzhou (CN)

(21) Appl. No.: 12/984,778

(22) Filed: Jan. 5, 2011

Related U.S. Application Data
(63) Continuation-in-part of application No. 12/423,110, filed on Apr. 14, 2009.

(51) Int. Cl. F21V 33/00

(52) U.S. Cl. 362/133

(57) ABSTRACT

A high voltage under-cabinet puck light is disclosed where the reflector is assembled to be flush with the housing and contains a plurality of air holes for better heat dissipation and air ventilation, by screwing the reflector to the anchorings built to the inside wall of the housing; a plurality of cut slits are made to the surface of the reflector, to aid the heat dissipation while the effective light-reflecting area is compensated for by the bevel surfaces made to the edge of each cut slit.

### RELATED PRIOR APPLICATION AND PRIORITY CLAIM

The present application is a Continuation-In-Part of an earlier application, Ser. No. 12/423,110, filing date Apr. 14, 2009, by the same inventor (please note that inventor name is Zhirong Lee as stated in the Application Data Sheet filed on Apr. 14, 2009. A new Declaration is submitted herewith), and incorporate the prior disclosure of the earlier application, with additional disclosure of new matters introduced and claimed herein, and for purpose of claiming the priority as afforded under applicable laws.

### FIELD AND BACKGROUND OF THE INVENTION

The present invention disclosed and claimed a particular light for use on sides or walls of furniture or cabinetry to produce decorate lighting effect in the vicinity of the furniture or cabinets. For cabinets, and in particular kitchen wall cabinets, this type of light is mounted to a lower exterior surface or recessed therein, for providing lighting to countertop surfaces below the cabinets.

One type of lighting fixture is known as an under-cabinet puck light. These lights are generally cylindrical disc-shaped housings. The housings contain a reflector, a lamp socket with a light bulb, and a glass lens for transmitting light from the housing to the countertop surface below the cabinet. The socket connects to a supply of electrical current.

Most puck lights use low voltage power source and thus do not produce much heat and there is not much issue of heat dissipation that needs to be addressed in terms of product design, manufacturing or installation. The shortcoming for such low voltage puck light is that the lighting brightness is limited, by its very nature of low voltage and lower power efficiency.

When “high voltage” system using the regular 120v household power is adopted, the heat-dissipation is an important factor. (*Note that for purpose of description herein and for purpose of standard usage in the countries that use the 120v standard voltage, including North America, the 120v and the 110v specs are interchangeable that do not involve and step-up transform from 110v to 120v, as in the case of 120v to 240v, or vice versa.*)

Accordingly, there is a need for alternative configuration of an under-cabinet lighting fixture regarding surface and recessed mounting and operating on high line voltage for increased illumination with controlled transfer of the heat.

An example of such heat-dissipation design is the Benesohn U.S. Pat. No. 6,491,413 (“413 patent”). 413 patent disclosed and claimed a high-voltage puck light, wherein the reflector (60) sits NOT directly on the flange of the housing unit (12), but on some projections (posts 18) of the flange, so that a gap (an air passage way) between the reflector and the housing is created, allowing air to circulate through this gap, achieving some degree of heat dissipation.

The inventor Benesohn had another invention, now U.S. Pat. No. 6,979,107 (“Benesohn 107 patent”). Benesohn 107 patent disclosed and claimed a high-voltage puck light that is close to the disclosure in present application; however, Benesohn 107 patent lacks the important features of cut-slits on the surface of the reflector, which provides two benefits: (1) additional heat dissipation, and (2) bevel surfaces around the cut-slit to provide effective reflective areas not substantially reduced due to the existence of the slit, as well as some decorative light patterns, to increase the visual attractiveness.

### OBJECTS AND SUMMARY OF THE INVENTION

Present invention provides a well-ventilated puck light design wherein the reflector is assembled to the housing with heat dissipation holes made to the flange portion of the reflector, creating good air passage to cool the heat associated with the use of high-voltage lamp that can produce better lighting effect. Additionally, heat dissipating slits are made on the surface, with bevel surfaces made around the edge of the cut slit, to increase and compensate for the reduced areas of the effective reflecting surface, so that the level of brightness is not adversely affected and some additional decorative light patterns are provided.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows the components and construction of the puck light without the assembly surface can.

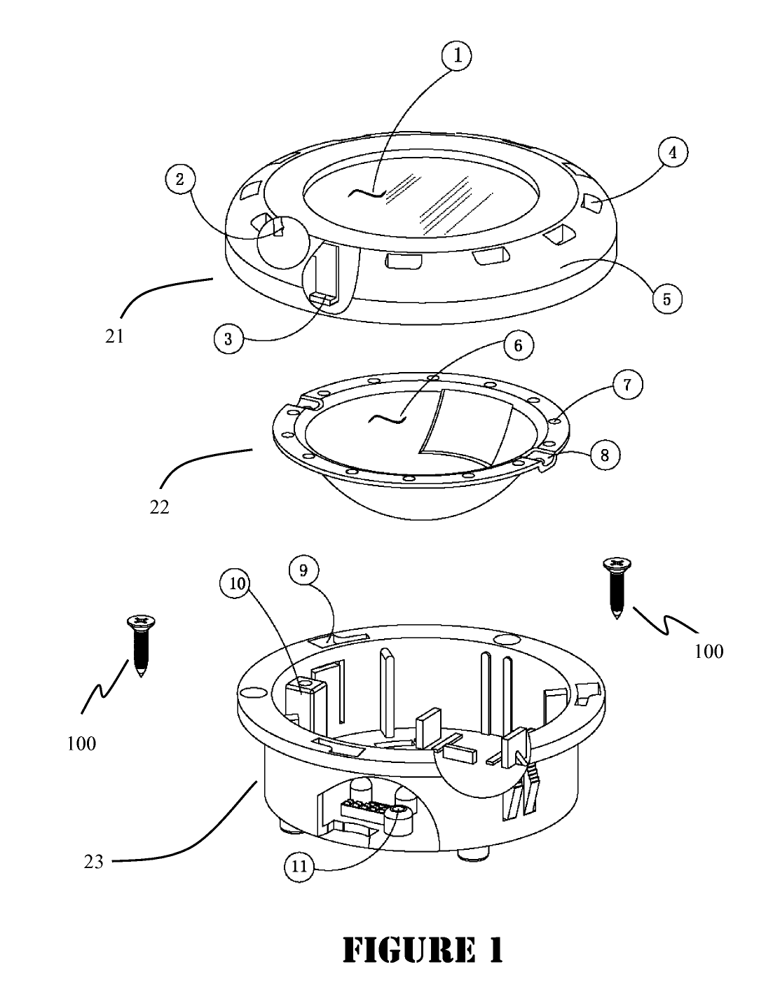

FIG. 2 shows the housing as detached from the assembly surface can.

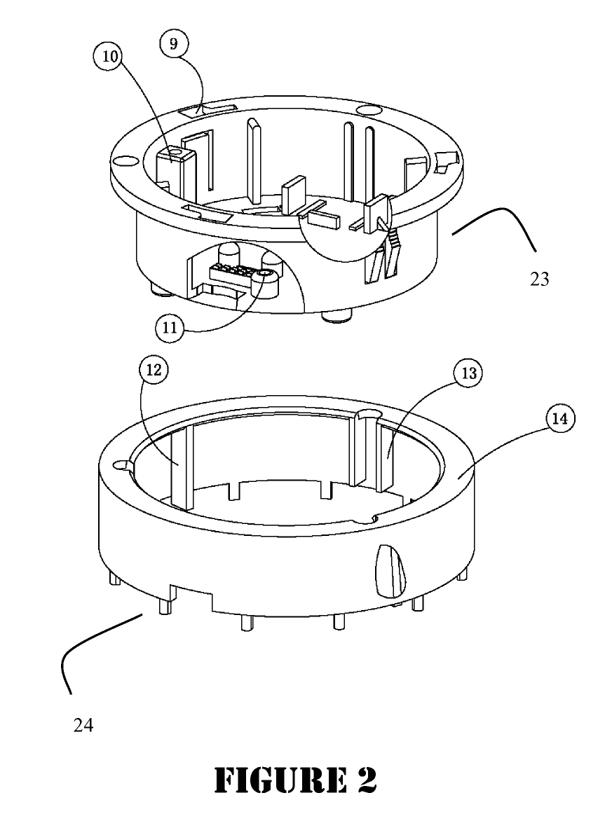

FIG. 3 shoes the existence of a plurality of cut slits, with bevel surfaces shown on the edges of each slit.

### DETAILED DESCRIPTION OF THE PREFERRED EMBODIMENT

The puck light of present invention is made up of four (4) major parts (from top to bottom): cap 21, reflector 22, housing 23 and an assembly surface can 24. These four pieces are the general structure of a puck light.

However, to allow for the use of high voltage lamp directly hooking up to 120v power line without the use of a transformer, heat dissipation design becomes important and is thus built in to the structure of present invention.

A cylinder-shaped housing 23 has an open end and a base. A flange portion is built around the lip of the open end of said housing 23, for purpose of connecting a cap 21, to be discussed later.

At the base of said housing 23, there are some openings, for purpose of placing lamp socket and for power cord connecting to the lamp socket.

Along the inside wall of housing 23, two screw anchorings 10 are located opposite of each other. These two screw anchorings 10 are sized to receive the two screws 100 that will be used to secure reflector 22 to the housing 23, through the locking holes 8 on the flange portion of the reflector 22.

The reflector 22 is shaped like a bowl and have a flange portion around the lip, so that its diameter is sized to fit the inside diameter of said housing 23. The reflector 22 has an opening near its center portion sized for placing a lamp and the seat/socket of the lamp.

The flange portion of the reflector 22 contains some air holes 7. When the reflector 22 is assembled to the housing 23, by screws 100 through the locking holes 8 to the anchorings 10, as described in the paragraphs above, the flange portion of the reflector 22 is flush on the same plane as the flange portion of the housing 23.

Also, a ring of air holes 7 is evenly spaced around the flange portion of the reflector 22, to provide heat ventilation and dissipation.

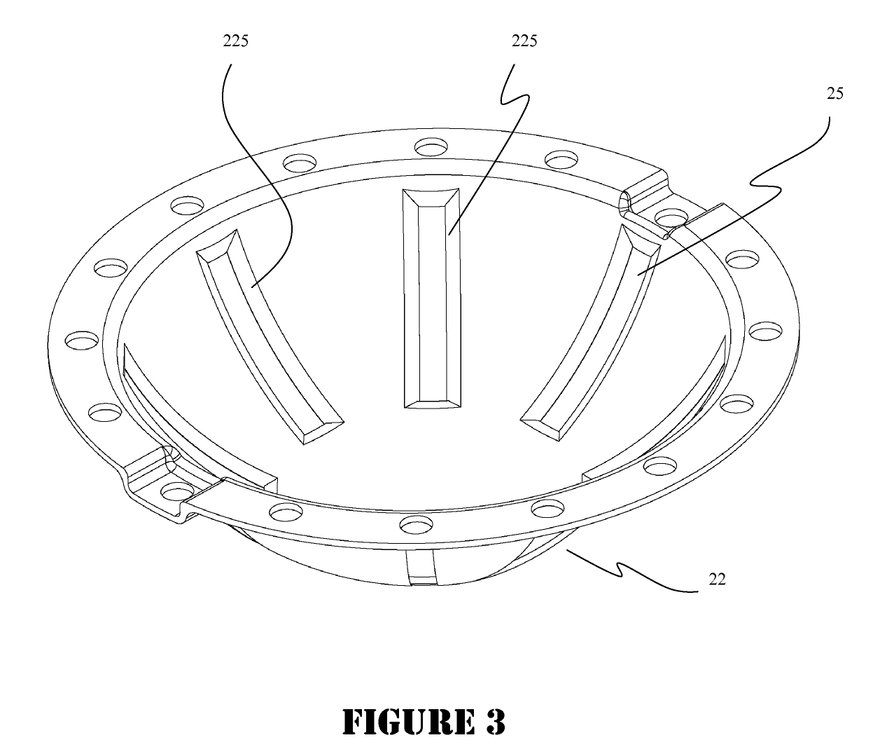

Additionally, a plurality of cut slits 25 are made evenly on the surface of the reflector 22, as shown in FIG. 3.

Due to the inherent thickness of the reflector 22 material, some bevel surfaces 225 are made around the edge of each cut slit 25, so that the bevel surfaces also serve as “effective” area for reflecting light.

By doing so, the cut-away surface on the reflector is compensated by the existence of the bevel surfaces 225 around the slit 25, resulting in good heat dissipation while the effective light-reflecting area is not adversely affected.

The cap 21 defines a central opening to contain a glass or a lens 1, secured by glass locking tab 2. A bevel surface 5 exists around the central opening/glass piece 1. A plurality of light diffusing holes 4 is evenly located on the bevel surface 5, to provide decorate lighting effect and for air ventilation purpose.

The decorative pattern created by light diffusing holes 4 on the bevel surface 5 of cap 21 is independent of the light pattern created by the bevel surface 225 on the slit 25 of the reflector 22, which also served the function of increasing the heat dissipation.

Cap 21 is secured to the flange portion of the housing 23 by a plurality of cap locking pieces 3 and the corresponding cap locking holes 9 on the flange portion of housing 23.

An assembly surface can 24 is provided to snugly receive the housing 23, when the reflector 22 is secured to the housing 23 and the cap 21 is secured to the housing 23.

The installation of socket, lamp and power cord going through the openings in the housing 23 and through the reflector 22 is known part. This part alone does not form the inventive basis of this application and requires no disclosure herein.

What is claimed is:

1. A high-voltage under-cabinet puck light, comprising:
a cylinder-shaped housing defining an open end that opposes a base having a plurality of openings, said housing contain a flange portion around the open end with a plurality of cap locking holes;
two screw anchorings made to the inside wall of said housing;
a reflector defining a cavity with two locking holes matching said screw anchorings when assembled said reflector to said housing, said reflector contains an opening sized for placing a lamp and the seat of the lamp thereto, and said reflector contains a flange portion sized to fit snugly within the inside diameter of the open end of said housing;
a plurality of cut slits made on the surface of said reflector, with bevel surfaces made to the edge of each cut slit;
a cap with cap locking pieces protruding out for inserting into corresponding cap locking holes on the flange of said housing; and,
an assembly surface can sized to snugly receive said housing, when the reflector is secured to said housing and the cap is also secured to said housing.

2. The high-voltage under-cabinet puck light of claim 1, wherein said reflector and the flange portion of said reflector are flush on the same plane with the flange portion of said housing when assembled.

3. The high-voltage under-cabinet puck light of claim 2, further comprising a ring of air holes on the flange portion of said reflector.

4. The high-voltage under-cabinet puck light of claim 3, wherein said cap defines a central opening to receive a lens or glass piece secured by glass locking tabs.

5. The high-voltage under-cabinet puck light of claim 4, further comprising a ring of light diffusing holes on the bevel surface of said cap, around said lens or glass piece.
